(19) United States
(12) Patent Application Publication
(10) Pub. No.: US 2026/0277632 A1
(43) Pub. Date: Sep. 17, 2026

(54) INFORMATION PROCESSING METHOD, APPARATUS, ELECTRONIC DEVICE AND STORAGE MEDIUM

(71) Applicant: Beijing Youzhuju Network Technology Co., Ltd., Beijing (CN)

(72) Inventors: Yang CHENG, Beijing (CN); Yangtao ZHANG, Beijing (CN)

(21) Appl. No.: 19/469,209

(22) PCT Filed: May 30, 2024
(86) PCT No.: PCT/CN2024/096334

§ 371 Date: Sep. 25, 2025

(30) Foreign Application Priority Data
May 31, 2023 (CN) 202310637364.X

(51) Int. Cl. G06F 9/451; G06F 9/445

(52) U.S. Cl. CPC G06F 9/451; G06F 9/44521

(57) ABSTRACT

The present disclosure relates to a method and apparatus for information processing, an electronic device and a storage medium. The method comprises: obtaining a page loading instruction comprising identification information of a page to be loaded, wherein the page to be loaded comprises a target configurable area and a target non-configurable area; rendering the page to be loaded using first target resource information and second target resource information; wherein the first target resource information corresponds to the target configurable area; the first target resource information is variable resource information and determined according to current promotion activity contents; and the second target resource information corresponds to the target non-configurable area; and the second target resource information is fixed resource information, which does not vary with changes of promotion activity contents.

This application claims priority to Chinese Application No. 202310637364.X entitled as “INFORMATION PROCESSING METHOD, APPARATUS, ELECTRONIC DEVICE AND STORAGE MEDIUM” filed on May 31, 2023, the disclosure of which is incorporated herein by reference in its entirety.

### FIELD

The present disclosure relates to computer technology field, and in particular relates to a method and apparatus for information processing, an electronic device and a storage medium.

### BACKGROUND

The current page development mode is to develop the entire page. Specifically, in case of a new page development need, it is required to develop each area of the entire page, which may cause repeated developments and high development costs.

### SUMMARY

To address or at least partly solve the above technical problem, the present disclosure provides a method and apparatus for information processing, an electronic device and a storage medium.

In a first aspect, the present disclosure provides a method for information processing, comprising:
obtaining a page loading instruction comprising identification information of a page to be loaded, and the page to be loaded comprises a target configurable area and a target non-configurable area;
rendering the page to be loaded with first target resource information and second target resource information; wherein the first target resource information corresponds to the target configurable area; the first target resource information is variable resource information and determined according to current promotion activity contents; and the second target resource information corresponds to the target non-configurable area; and the second target resource information is fixed resource information, which does not vary with changes of promotion activity contents.

In a second aspect, the present disclosure provides an apparatus for information processing, comprising:
a page loading instruction obtaining module for obtaining a page loading instruction comprising identification information of a page to be loaded, and the page to be loaded comprises a target configurable area and a target non-configurable area;
a rendering module for rendering the page to be loaded with first target resource information and second target resource information; wherein the first target resource information corresponds to the target configurable area; the first target resource information is variable resource information and determined according to current promotion activity contents; and the second target resource information corresponds to the target non-configurable area; and the second target resource information is fixed resource information, which does not vary with changes of promotion activity contents.

In a third aspect, the present disclosure provides an electronic device, comprising:
one or more processors;
a storage apparatus for storing one or more programs;
wherein the one or more programs, when executed by the one or more processors, cause the one or more processor to implement the above method for information processing.

In a fourth aspect, the present disclosure provides a computer-readable storage medium stored thereon with computer programs, wherein the programs, when executed by a process, implement the above method for information processing.

### BRIEF DESCRIPTION OF THE DRAWINGS

The drawings here are incorporated into the description as a part of it, illustrate the embodiments compliant with the present disclosure, and are combined with the description to explain the principles of the present disclosure.

To more clearly explain the technical solution in the embodiments of the present disclosure or in the prior art, the drawings needed in the description of the embodiments or the prior art are to be introduced simply below. Apparently, those skilled in the art also may obtain other drawings from those illustrated without any exercises of inventive work.

FIG. 1 illustrates a flowchart of the method for information processing provided by an embodiment of the present disclosure;

FIG. 2 illustrates a flowchart of a method for establishing the binding relation among the configurable area, the material template and the configuration information provided by an embodiment of the present disclosure;

FIG. 3 illustrates a schematic diagram of a target page provided by an embodiment of the present disclosure;

FIGS. 4-14 illustrate schematic diagrams of several material templates provided by embodiments of the present disclosure;

FIG. 15 illustrates a structural diagram of an apparatus for information processing according to embodiments of the present disclosure;

FIG. 16 illustrates a structural diagram of an electronic device in the embodiments of the present disclosure.

### DETAILED DESCRIPTION OF EMBODIMENTS

For a clearer understanding of the above objectives, features and advantages of the present disclosure, the solution of the present disclosure is to be further described below. It is to be appreciated that embodiments of the present disclosure and features within the embodiments may be combined with one another without causing conflicts.

Many details are elaborated in the following description to provide a more comprehensive understanding of the present disclosure. However, the present disclosure also may be implemented in different ways than those described here. Apparently, the embodiments disclosed in the description is only a part of the embodiments of the present disclosure, rather than all of them.

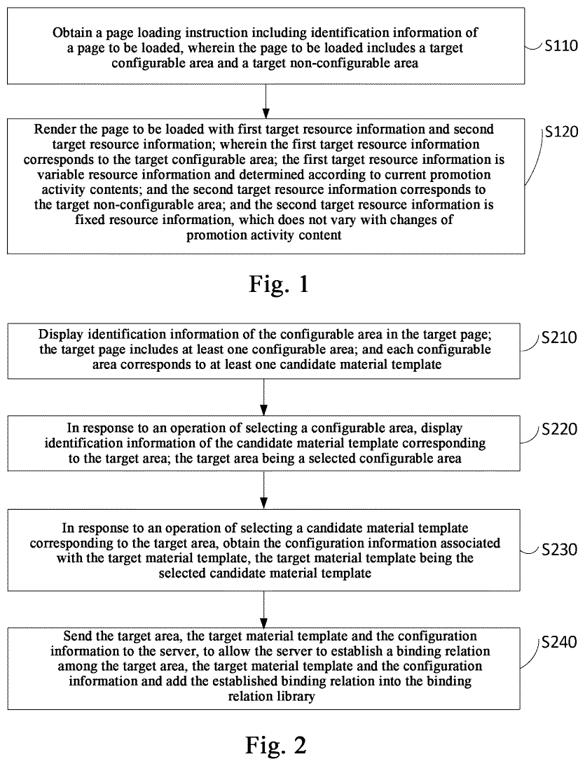

FIG. 1 illustrates a flowchart of the method for information processing provided by an embodiment of the present disclosure. This embodiment is suitable for page loading at a client. The method may be executed by the apparatus for information processing, and the apparatus may be implemented by software and/or hardware. The apparatus may be configured in an electronic device, such as terminal, comprising but not limited to, smartphone, palm computer, tablet computer, wearable device with display screen, desktop computer, notebook computer, all-in-one machine, smart home device and the like.

Referring to FIG. 1, the method for information processing comprises:

S110: A page loading instruction comprising identification information of a page to be loaded is obtained, and the page to be loaded comprises a target configurable area and a target non-configurable area.

The page loading instruction, for example, may be an instruction for passing an expectation of opening a page to be loaded to a user terminal. As an example, in response to a user's operation of triggering a control or area in a page presented on the user terminal, the user terminal generates the page loading instruction.

The page to be loaded refers to a page that the user expected to open by the operation of triggering a particular control or area in the page presented on the user terminal.

Identification information of the page to be loaded, for example, may be information to distinguish the page to be loaded from other pages. The type of the page to be loaded may be uniquely determined based on the identification information of the page to be loaded. Alternatively, identification information of the page to be loaded is URL (uniform resource locator) of the page.

The target configurable area and the target non-configurable area are pre-assigned in the page to be loaded and do not overlap with each other. The resource information for rendering the target configurable area and the resource information for rendering the target non-configurable area differ in variability, so the areas in the page to be loaded are distinguished. Variability of the resource information may refer to the explanations regarding “variable resource information” and “non-variable resource information” below and will not be repeated here.

It is to be explained that a page to be loaded in practice may include one or more target configurable areas and one or more target non-configurable areas.

S120: The page to be loaded is rendered with first target resource information and second target resource information; wherein the first target resource information corresponds to the target configurable area; the first target resource information is variable resource information and determined according to current promotion activity contents; and the second target resource information corresponds to the target non-configurable area; and the second target resource information is fixed resource information, which does not vary with changes of promotion activity contents.

The promotion activity indicates an event delivered to increase popularity or interest of a target object among users. In e-commerce, the promotion activity specially may include marketing campaigns, such as low-price promotion activities, special offers when spending enough and the like. It is to be explained that the promotion activity usually is time sensitive, which means that the promotion activity is often delivered within a designated period of time. The current promotion activity means the promotion activity being carried out at the moment. The promotion activity content indicates substantive objects included in the promotion activity. As an example, if the promotion activity is a sales promotion, the promotion activity contents include which commodity is on sales and how is the strength of the promotion etc. The current promotion activity content refers to the substantive objects included in the currently delivered promotion activity.

The resource information indicates the information for rendering the page, and specifically may include image and/or text to be displayed in the page.

The target resource information refers to the information for rendering the page to be loaded.

“The first target resource information corresponds to the target configurable area” means that the first target resource information is used to render the target configurable area. “The first target resource information is determined according to current promotion activity contents” means that it is determined by the current promotion activity contents what images and/texts are used as the first target resource information. Apparently, if the current promotion activity contents are different, the first target resource information also varies. In other words, the same page is loaded at different moments; in case that the promotion activity contents at the loading moment are different, the first target resource information to be used may not be exactly the same, or is completely different. In such case, the first target resource information is the variable resource information. As an example, the page 1 is loaded at moment M; according to the promotion activity contents A at the moment M, it is determined that the first target resource information comprises picture a and picture b; subsequently, the configurable area of the page 1 is rendered using the picture a and the picture b. The page 1 is loaded again at moment N; according to the promotion activity contents at the moment N (the promotion activity contents A are not exactly the same as the promotion activity contents B), it is determined that the first target resource information comprises picture c and picture d; subsequently, the configurable area of the page 1 are rendered using the picture c and the picture d, rather than the picture a and the picture b.

“The second target resource information corresponds to the target non-configurable area” means that the second target resource information is used to render the target non-configurable area. “The second target resource information is fixed resource information, which does not vary with changes of promotion activity contents” means that the second target resource information is pre-assigned and irrelevant to the promotion activity contents. As an example, the pre-assigned second target resource information comprises picture c and picture d; despite there is a promotion activity at the page loading moment or not or which promotion activity is carried out, the picture c and the picture d are always used as the second target resource information.

The above technical solution configures the first target resource information and the second target resource information and uses them to render the page to be loaded; wherein the first target resource information corresponds to the target configurable area; the first target resource information is variable resource information and determined according to current promotion activity contents; and the second target resource information corresponds to the target non-configurable area; and the second target resource information is fixed resource information, which does not vary with changes of promotion activity contents. The essence is to divide the page to be loaded into a target configurable area and a target non-configurable area. When the page to be loaded is configured, only the target configurable area is configured according to the promotion activity contents, while the target non-configurable area is not configured. Accordingly, in developing the page to be loaded, only the configurable area in the page to be loaded is developed according to the development requirements instead of all areas in the page to be loaded. Therefore, the costs for repeated development may be sufficiently reduced.

Based on the above various technical solutions, alternatively, before S120, the method also may include steps of: the page loading instruction is sent to a server, to allow the server to determine the first target resource information and the second target resource information based on identification information of the page to be loaded; obtaining from the server the first target resource information and the second target resource information.

The essence of such setting is that the first target resource information and the second target resource information are determined by the server and sent to the user terminal. Accordingly, the computation load at the user terminal may be sufficiently reduced, so as to further lower the performance requirements on the user terminal.

Furthermore, the server determining the first target resource information based on identification information of the page to be loaded comprises: the server determines a target binding relation corresponding to the target configurable area from a binding relation library based on identification information of the page to be loaded; the binding relation library comprises a plurality of binding relations, the binding relations comprise a corresponding relation among configurable area, material template and configuration information; at least one of the configurable area, the material template and the configuration information is different in different binding relations; and the binding relation is built according to the promotion activity contents; the server also determines the first target resource information corresponding to the target configurable area based on the target binding relation.

The binding relation library is used for storing a set of pre-established binding relations. The binding relation is pre-established according to the promotion activity contents. The process for establishing the binding relation may be regarded as a process of page development.

Alternatively, the target configurable area corresponds to a plurality of candidate material templates; each of the candidate material templates comprises one or more items to be configured; the material template in the target binding relation is a candidate material template of the plurality of candidate material templates corresponding to the target configurable area; and the configuration information in the target binding relation is information for configuring the items to be configured in the material template in the target binding relation. In other words, the template binding relation defines which candidate material templates need to be used for rendering the configurable area and which and how configuration items in the candidate material template are configured etc.

Alternatively, the configuration information comprises display information and/or delivery information; the display information comprises at least one of: background color, background image, title content, font color, jump link after triggering of the target configurable area, dynamic material library identifier, dynamic material screening condition and dynamic material presentation strategy; the delivery information comprises delivery period.

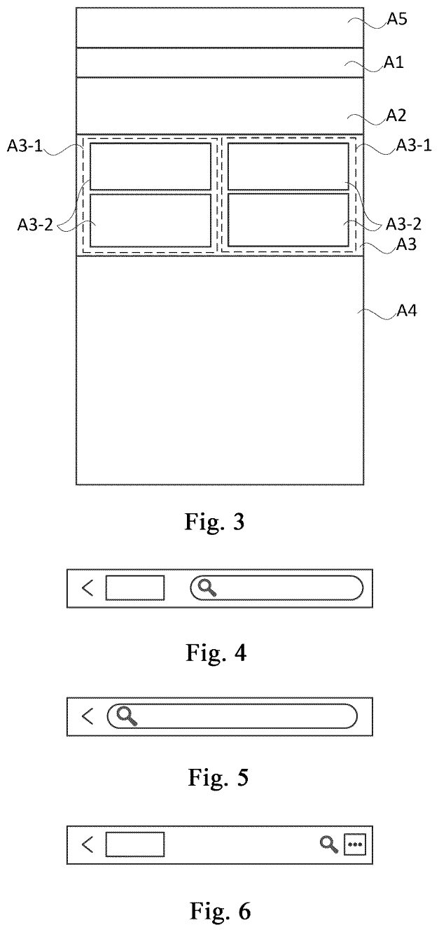

To facilitate understanding, FIG. 2 illustrates a flowchart of a method for establishing the binding relation. The method for establishing the binding relation is executed by a terminal for page development. Referring to FIG. 2, the method for establishing the binding relation comprises:

S210: identification information of the configurable area is displayed in the target page; the target page comprises at least one configurable area; and each configurable area corresponds to at least one candidate material template.

The target page, for example, may be a page expected to be developed. As an example, if the development need is to present information of a given marketing campaign (e.g., special offer when spending enough) on a traffic guiding page of an e-commerce platform, the traffic guiding page of the e-commerce platform is the target page, wherein the traffic guiding page of the e-commerce platform, for example, may be a page guiding a user to view and purchase commodities selling on the e-commerce platform. As an example, the traffic guiding page of the e-commerce platform comprises a mall homepage.

The configurable area may be pre-defined, and the area of the contents presented may be adjusted according to the marketing campaign.

The technical solution according to this embodiment of the present disclosure configures the first target resource information and the second target resource information and uses them to render the page to be loaded; wherein the first target resource information corresponds to the target configurable area; the first target resource information is variable resource information and determined according to current promotion activity contents; and the second target resource information corresponds to the target non-configurable area; and the second target resource information is fixed resource information, which does not vary with changes of promotion activity contents. The essence is to divide the page to be developed into a configurable area and a non-configurable area. The essence is to divide the page to be loaded into a target configurable area and a target non-configurable area. When the page to be loaded is configured, only the target configurable area is configured according to the promotion activity contents, while the target non-configurable area is not configured. Accordingly, in developing the page to be loaded, only the configurable area in the page to be loaded is developed according to the development requirements instead of all areas in the page to be loaded. Therefore, the costs for repeated development may be sufficiently reduced.

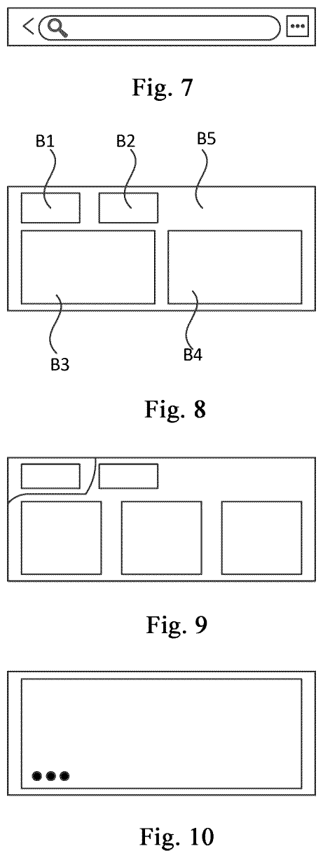

FIG. 3 illustrates a schematic diagram of a target page provided by an embodiment of the present disclosure. Referring to FIG. 3, the target page comprises a plurality of areas, respectively being area A1, area A2, area A3, area A4 and area A5, wherein the area A3 may be further divided into two areas A3-1. Each of A3-1 is further divided to two areas A3-3. It may be predefined which ones of the above areas are configurable areas and which ones are the non-configurable areas. As an example, assuming that the page is the mall homepage, it is defined that the area A2 in the page is the non-configurable area for permanently presenting logistics information of the commodity purchased by the user. It is also defined that other areas apart from the area A2 are configurable areas.

The identification information of the configurable area refers to information that can distinguish one configurable area from other configurable areas. Based on the identification information of a configurable area, it can be uniquely determined that the configurable area is which area of which page in an application of what version. The identification information of the configurable area corresponds to coordinates of the configurable area.

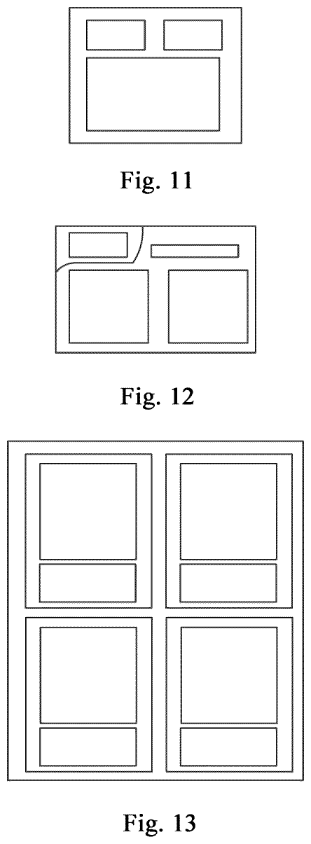

Candidate material template, for example, may be a template pre-designed for the configurable area and defining a layout style. The specific layout style of the candidate material template is not restricted in the present disclosure. FIGS. 4-14 illustrate schematic diagrams of several candidate material templates provided by embodiments of the present disclosure, wherein area A1 and area A5 in FIG. 3 both correspond to the candidate material templates as shown in FIGS. 4-7. Area A3 in FIG. 3 corresponds to the candidate material templates shown in FIGS. 8-10. Area A3-1 and area A3-2 in FIG. 3 correspond to the candidate material templates shown in FIGS. 11-12. Area A4 in FIG. 3 corresponds to the candidate material templates shown in FIGS. 13-14.

Alternatively, each candidate material template only defines the layout style without comprising the information that users want to present to the users. In other words, the candidate material template comprises one or more items to be configured, and the items to be configured may be regarded as vacancy. Page developers are required to configure the items to be configured in view of the development requirements, i.e., complete the items to be configured. Detailed contents or types of the items to be configured are not restricted in the present disclosure.

Furthermore, the items to be configured included in the candidate material template may be divided into two categories, one of which is display category configuration item and the other is delivery category configuration item. The display category configuration item, for example, may be a configuration item for defining which type of content is to be displayed. As an example, referring to FIG. 8, the candidate material template comprises five areas, respectively being area B1, area B2, area B3, area B4 and area B5, the area B5 surrounding the areas B1-B4. Content, type and the like to be displayed in each area are considered as display category configuration item. The delivery category configuration item, for example, may be used for defining the page comprising the configured candidate material template and when the delivery is performed.

In some embodiments, the display category configuration items may be further divided into static display category configuration item and dynamic display category configuration item, wherein the static display category configuration item refers to presenting texts or images configured by the static display category configuration item in a static form when the developed target page is in a display state. The texts and images would not change with time elapse or user operation etc. The dynamic display category configuration item indicates presenting texts or images configured by the dynamic display category configuration item in a dynamic form when the developed target page is in a display state. The texts and images would change with time elapse and/or user operation etc.

As an example, as defined in FIG. 8, the area B1 is a static configuration item for presenting a main title; the area B2 is a static configuration item for presenting a sub-title; the area B5 is a static configuration item for presenting the background image; and areas B3 and B4 are dynamic configuration items for presenting commodity images.

Each candidate material template has identification information corresponding thereto. One candidate material template may be distinguished from other candidate material templates based on the identification information of the candidate material template. The identification information of the candidate material template, for example, may be title, serial number or image of the candidate material template.

The essence of this step is to present the identification information of all configurable areas in the target page after the target page is determined by the user, such that the page developers may select the configurable area according to the development requirements. When the page developers select a configurable area, it indicates that the page developers expect to develop the selected configurable area.

In some scenarios, the target page is the page to be loaded as mentioned above. In such case, the method for establishing the binding relation is executed earlier than the method for information processing provided in FIG. 1. The configurable area in the target page is the target configurable rea in the page to be loaded as shown in FIG. 1.

S220: in response to an operation of selecting a configurable area, identification information of the candidate material template corresponding to the target area is displayed; and the target area is a selected configurable area.

The essence of this step is that after the page developers select a configurable area, the identification information of all candidate material templates corresponding to the selected configurable area is presented, so as to allow the page developers to choose the candidate material template. When a candidate material template is selected by the page developers, it indicates that the page developers expect to use the selected candidate material template in the selected configurable area.

S230: in response to an operation of selecting a candidate material template corresponding to the target area, the configuration information associated with the target material template is obtained, and the target material template is the selected candidate material template.

The configuration information associated with the target material template, for example, may be information for configuring configurable items of the target material template. In other words, the configuration information associated with the target material template, for example, may be the information for completing the items to be configured in the target material template.

Alternatively, the configuration information comprises display information and delivery information; the display information comprises at least one of: background color, background image, title content, font color, jump link after triggering of the target area, dynamic material library identifier, dynamic material screening condition and dynamic material presentation strategy; the delivery information comprises at least one of: delivery time.

The jump link after triggering the target area, for example, may be a link address of a page to be displayed on the terminal after the jump when the user triggers the target area provided with a jump function. The background color, the background image, the title content, the font color, and the jump link after triggering of the target area are used for configuring the static display configuration items.

The dynamic material library identifier, the dynamic material screening condition, and the dynamic material presentation strategy are used to configure the dynamic display configuration items. The dynamic material library identifier defines from which material library the material presented in the dynamic material presentation area is selected. The dynamic material screening condition defines which materials in the material library may be presented in the dynamic material presentation area. The dynamic material presentation strategy defines in what form the selected material shows its dynamic presentation effect.

As an example, continuing with FIG. 8, as defined, the area B3 is a dynamic material presentation area for displaying commodity images. The dynamic material library identifier specifies from which commodity database the commodity image presented in the area B3 is selected. The dynamic material screening condition, for example, may be commodity having a price range from 10 to 100 RMB, or commodity having a sales volume of 1000 within one month, and the like. The dynamic material screening condition is used to screen the commodities in the commodity database. The dynamic material presentation strategy, for example, may be updating the commodity images presented in the area B3 once at an interval of a preset time, or updating the commodity images presented in the area B3 once upon detection of an operation of clicking the page by the user. Besides, the update of area B3 indicates that the commodity images presented in area B3 before the update are not exactly the same as the commodity images displayed in area B3 after the update.

S240: The target area, the target material template, and the configuration information are sent to the server, to allow the server to establish a binding relation among the target area, the target material template, and the configuration information and add the established binding relation into the binding relation library.

The above technical solution presents identification information of the configurable area in the target page, wherein the target page comprises at least one configurable area, and each configurable area corresponds to at least one candidate material template. The technical solution presents, in response to an operation of selecting a configurable area, identification information of the material template corresponding to the target area, the target area being a selected configurable area. The technical solution obtains, in response to an operation of selecting a material template corresponding to the target area, the configuration information associated with the target material template, the target material template being the selected material template. The technical solution sends the target area, the target material template and the configuration information to the server, to allow the server to establish a binding relation among the target area, the target material template and the configuration information and add the established binding relation into the binding relation library. The essence is to divide the target page into a plurality of areas and define whether each area may serve as the configurable area and the material template corresponding to the configurable area. As such, in view of the development requirements, one or more configurable area to be developed in the target page are selected and developed separately. Therefore, there is no need for developing all areas in the target page and the costs of the repeated development may be sufficiently decreased.

Based on the above various technical solutions, alternatively, the configuration information comprises the delivery information; the delivery information comprises the delivery period; and the target binding relation is a binding relation currently in the delivery period. In case that the current moment is within a delivery period of a binding relation, it means that the promotion activity running at this moment is a promotion activity for forming the binding relation, where the binding relation is valid. This setting in essence ensures that the target binding relation is related to the current promotion activity, which further guarantees that the rendered configurable area can implement the purpose of boosting the smooth process of the current promotion activity.

Based on the above various technical solutions, alternatively, configuration information in the target binding relation comprises the display information, wherein the display information comprises the dynamic material library identifier, the dynamic material screening condition and the dynamic material presentation strategy; the dynamic material library comprises a plurality of materials; the server also determining the first target resource information corresponding to the target configurable area based on the target binding relation comprises: the server also determines from the dynamic material library first target resource information associated with the target configurable area based on the dynamic material library identifier and the dynamic material screening condition; the rendering the page to be loaded using first target resource information and second target resource information comprises: obtaining from the server the first target resource information, the second target resource information and the dynamic material presentation strategy; rendering the target configurable area in the page to be loaded based on the first target resource information and the dynamic material presentation strategy; rendering the target non-configurable area in the page to be loaded with the second target resource information.

As an example, if the dynamic material presentation strategy corresponding to the area B3 in FIG. 8 is to update the commodity images displayed in the area B3 once every 5 seconds in accordance with the target binding relation, the dynamic material presentation strategy and the first target resource information are together sent to the first terminal, such that the effect of updating the commodity images presented once every 5 seconds can be implemented in the area B3 of the page to be loaded after the first terminal renders the page to be loaded.

It should be noted that, for the convenience of description, the above various method embodiments are described as a series of act combinations. However, those skilled in the art should understand that the present disclosure is not restricted by the sequence of the described acts since certain steps may be executed in different sequences or concurrently according to the present disclosure. Further, those skilled in the art should understand that the embodiments described herein are preferred embodiments and the related acts and modules are not necessarily required by the present disclosure.

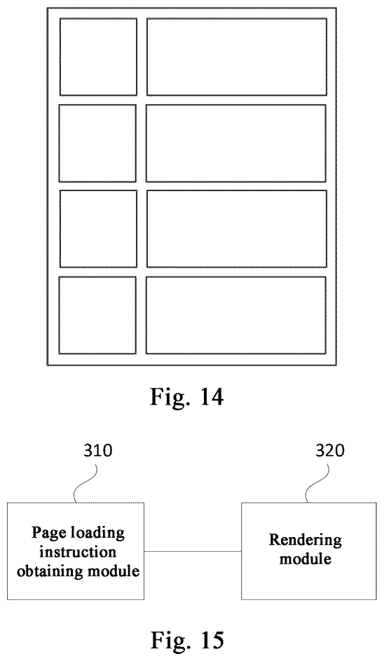

FIG. 15 illustrates a structural diagram of an apparatus for information processing according to embodiments of the present disclosure. The apparatus for information processing provided by the embodiments of the present disclosure may be configured in a terminal. As shown in FIG. 15, the apparatus for information processing specifically comprises:
a page loading instruction obtaining module 310 for obtaining a page loading instruction comprising identification information of a page to be loaded, the page to be loaded comprises a target configurable area and a target non-configurable area;
a rendering module 320 for rendering the page to be loaded with first target resource information and second target resource information; wherein the first target resource information corresponds to the target configurable area; the first target resource information is variable resource information and determined according to current promotion activity contents; and the second target resource information corresponds to the target non-configurable area; and the second target resource information is fixed resource information, which does not vary with changes of promotion activity contents.

Further, the apparatus also comprises an information transceiving module;

The information transceiving module is used for, before the rendering the page to be loaded with first target resource information and second target resource information, sending the page loading instruction to a server, to allow the server to determine the first target resource information and the second target resource information based on identification information of the page to be loaded;
obtaining from the server the first target resource information and the second target resource information.

Moreover, the server determining the first target resource information based on identification information of the page to be loaded comprises:
the server determines a target binding relation corresponding to the target configurable area from a binding relation library based on identification information of the page to be loaded; the binding relation library comprises a plurality of binding relations, the binding relations comprise a corresponding relation among configurable area, material template and configuration information; at least one of the configurable area, the material template and the configuration information is different in different binding relations; and the binding relation is built according to the promotion activity contents;
the server also determines the first target resource information corresponding to the target configurable area based on the target binding relation.

Moreover, the target configurable area corresponds to a plurality of candidate material templates; each of the candidate material templates comprises one or more items to be configured;
the material template in the target binding relation is a candidate material template of the plurality of candidate material templates corresponding to the target configurable area; and the configuration information in the target binding relation is information for configuring the items to be configured in the material template in the target binding relation.

Moreover, the configuration information comprises display information and/or delivery information;
the display information comprises at least one of: background color, background image, title content, font color, jump link after triggering of the target configurable area, dynamic material library identifier, dynamic material screening condition and dynamic material presentation strategy;
the delivery information comprises delivery period.

Furthermore, the configuration information comprises the delivery information; the delivery information comprises the delivery period; and the target binding relation is a binding relation currently in the delivery period.

Furthermore, configuration information in the target binding relation comprises the display information, wherein the display information comprises the dynamic material library identifier, the dynamic material screening condition, and the dynamic material presentation strategy; the dynamic material library comprises a plurality of materials;
the server also determining the first target resource information corresponding to the target configurable area based on the target binding relation, comprising:
the server also determines from the dynamic material library first target resource information associated with the target configurable area based on the dynamic material library identifier and the dynamic material screening condition;
the rendering module is used for:
obtaining the first target resource information, the second target resource information and the dynamic material presentation strategy from the server;
rendering the target configurable area in the page to be loaded based on the first target resource information and the dynamic material presentation strategy;
rendering the target non-configurable area in the page to be loaded with the second target resource information.

The apparatus for information processing provided by embodiments of the present disclosure may execute steps performed by the terminal in the method for information processing according to the embodiments of the present disclosure. The execution steps and the advantageous effects will not be repeated here.

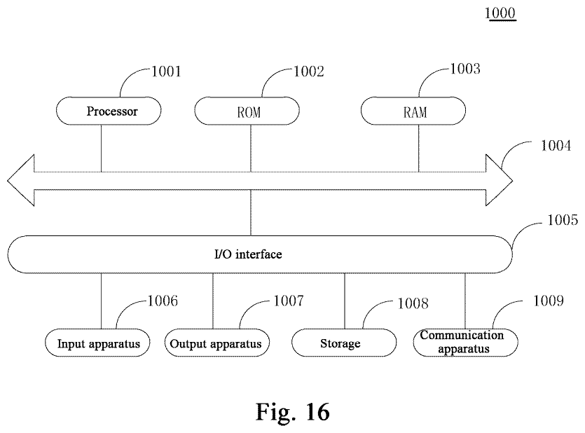

FIG. 16 illustrates a structural diagram of an electronic device in the embodiments of the present disclosure. According to FIG. 16, it demonstrates a structural diagram of an electronic device 1000 adapted to implement embodiments of the present disclosure. The electronic device 1000 in the embodiments of the present disclosure may include, but not limited to, mobile terminals, such as mobile phones, notebooks, digital broadcast receivers, PDA (Personal Digital Assistant), PAD (Portable Android Device), PMP (Portable Multimedia Player), vehicle terminals (such as car navigation terminal) and wearable electronic devices and fixed terminals, e.g., digital TVs, desktop computers and smart home devices etc. The electronic device shown in FIG. 16 is just an example and will not put any restrictions on the functions and application ranges of the embodiments of the present disclosure.

According to FIG. 16, the electronic device 1000 may include a processing unit (e.g., central processor, graphic processor and the like) 1001, which can execute various suitable actions and processing based on the programs stored in the read-only memory (ROM) 1002 or programs loaded in the random-access memory (RAM) 1003 from a storage 1008, so as to implement the method for information processing according to the embodiments of the present disclosure. The RAM 1003 can also store all kinds of programs and data required by the operations of the electronic device 1000. Processing unit 1001, ROM 1002 and RAM 1003 are connected to each other via a bus 1004. The input/output (I/O) interface 1005 is also connected to the bus 1004.

Usually, input apparatus 1006 (comprising touch screen, touchpad, keyboard, mouse, camera, microphone, accelerometer, gyroscope and like) and output apparatus 1007 (comprising liquid crystal display (LCD), speaker and vibrator etc.), storage 1008 (comprising tape and hard disk etc.) and communication apparatus 1009 may be connected to the I/O interface 1005. The communication apparatus 1009 may allow the electronic device 1000 to exchange information with other devices through wired or wireless communications. Although FIG. 16 illustrates the electronic device 1000 having various units, it is to be understood that it is not a prerequisite to implement or provide all illustrated units. Alternatively, more or less units may be implemented or provided.

In particular, in accordance with embodiments of the present disclosure, the process depicted above with reference to the flowchart may be implemented as computer software programs. For example, the embodiments of the present disclosure include a computer program product comprising computer programs carried on a non-transitory computer readable medium, wherein the computer programs include program codes for executing the method demonstrated by the flowchart, so as to implement the aforementioned method for information processing. In these embodiments, the computer programs may be loaded and installed from networks via the communication apparatus 1009, or installed from the storage 1008, or installed from the ROM 1002. The computer programs, when executed by the processing unit 1001, performs the above functions defined in the method according to the embodiments of the present disclosure.

It is to be explained the above disclosed computer-readable medium may be computer readable signal medium or computer readable storage medium or any combinations thereof. The computer-readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer-readable storage medium may be any tangible medium that contains or stores programs. The programs may be utilized by instruction execution systems, apparatuses or devices in combination with the same. In the present disclosure, the computer-readable signal medium may include an information signal propagated in baseband or as part of a carrier wave, carrying computer-readable program codes therein. Such propagated information signals may take many forms, comprising but not limited to, electromagnetic signals, optical signals, or any suitable combinations thereof. The computer readable signal medium may also be any computer readable medium in addition to the computer readable storage medium. The computer-readable signal medium may send, propagate, or transmit programs for use by or in connection with instruction execution systems, apparatuses or devices. Program codes contained on the computer-readable medium may be transmitted by any suitable media, comprising but not limited to: electric wires, fiber optic cables, and RF (radio frequency), etc., or any suitable combinations thereof.

In some implementations, clients and servers may communicate with each other via any currently known or to be developed network protocols, such as HTTP (Hyper Text Transfer Protocol) and interconnect with digital data communications in any forms or media (such as communication networks). Examples of the communication networks include Local Area Network (LAN), Wide Area Network (WAN), internet work (e.g., Internet) and end-to-end network (such as ad hoc end-to-end network), and any currently known or to be developed networks.

The above computer readable medium may be included in the aforementioned electronic device or stand-alone without fitting into the electronic device.

The above computer readable medium bears one or more programs. When the above one or more programs are executed by the electronic device, the electronic device is enabled to:
obtain a page loading instruction comprising identification information of a page to be loaded, wherein the page to be loaded comprises a target configurable area and a target non-configurable area;
render the page to be loaded using first target resource information and second target resource information; wherein the first target resource information corresponds to the target configurable area; the first target resource information is variable resource information and determined according to current promotion activity contents; and the second target resource information corresponds to the target non-configurable area; and the second target resource information is fixed resource information, which does not vary with changes of promotion activity contents.

Alternatively, when the above one or more programs are executed by the electronic device, the electronic device also may perform all other steps described by the above embodiments.

Computer program instructions for executing operations of the present disclosure are written in one or more programming languages or combinations thereof. The above programming languages include, but not limited to, object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, comprising local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit should not be considered as the restriction over the unit per se.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

According to one or more embodiments of the present disclosure, there is provided an electronic device, comprising:
one or more processors;
a storage unit for storing one or more programs;
wherein the one or more programs, when executed by the one or more processors, cause the one or more processor to implement any methods for information processing according to the present disclosure.

According to one or more embodiments of the present disclosure, there is provided a computer-readable storage medium stored thereon with computer programs, wherein the programs, when executed by a process, implement any methods for information processing according to the present disclosure.

Embodiments of the present disclosure also provide a computer program product comprising computer programs or instructions, which computer programs or instructions, when executed by a processor, implement the above method for information processing.

It is to be explained that relational terms such as “first” and “second” in the text are disclosed only to distinguish one entity or operation from a further entity or operation without requiring or suggesting any actual relations or sequences between these entities or operations. Besides, the terms “comprise”, “contain” or any other variants are not featured with exclusiveness. Accordingly, the procedure, method, object or device comprising a series of factors may also include other factors not clearly listed in addition to those stated. Alternatively, inherent factors of the procedure, method, object or device are also included. The procedure, method or device comprising factors defined by the expression of “comprising one . . . ” may also contain other same factors if no more restrictions are provided.

The above is just the specific implementations of the present disclosure, which are provided for those skilled in the art to understand or implement the present disclosure. Many modifications to the embodiments are obvious for those skilled in the art. General principles defined in the text may be implemented in other embodiments without deviating from the spirit or scope of the present disclosure. Therefore, the present disclosure will not be restricted to the embodiments disclosed herein and instead has a broadest scope consistent with the principles and novel features disclosed here.

1. A method for information processing, comprising:
obtaining a page loading instruction comprising identification information of a page to be loaded, the page to be loaded comprising a target configurable area and a target non-configurable area; and
rendering the page to be loaded with first target resource information and second target resource information; wherein the first target resource information corresponds to the target configurable area; the first target resource information is variable resource information and determined according to current promotion activity contents; and the second target resource information corresponds to the target non-configurable area; and the second target resource information is fixed resource information, which does not vary with changes of promotion activity contents.

2. The method of claim 1, wherein before the rendering the page to be loaded with first target resource information and second target resource information, comprising:
sending the page loading instruction to a server, to cause the server to determine the first target resource information and the second target resource information based on identification information of the page to be loaded; and
obtaining the first target resource information and the second target resource information from the server.

3. The method of claim 2, wherein,
the server determines the first target resource information based on identification information of the page to be loaded, comprising:
the server determines a target binding relation corresponding to the target configurable area from a binding relation library based on identification information of the page to be loaded; the binding relation library comprises a plurality of binding relations, the binding relations comprise a corresponding relation among configurable area, material template and configuration information; at least one of the configurable area, the material template and the configuration information is different in different binding relations; and the binding relation is built according to the promotion activity contents; and
the server further determines the first target resource information corresponding to the target configurable area based on the target binding relation.

4. The method of claim 3, wherein,
the target configurable area corresponds to a plurality of candidate material templates; each of the candidate material templates comprises one or more items to be configured;
the material template in the target binding relation is a candidate material template of the plurality of candidate material templates corresponding to the target configurable area; and the configuration information in the target binding relation is information for configuring the items to be configured in the material template in the target binding relation.

5. The method of claim 3, wherein the configuration information comprises display information and/or delivery information;
the display information comprises at least one of: background color, background image, title content, font color, jump link after triggering of the target configurable area, dynamic material library identifier, dynamic material screening condition and dynamic material presentation strategy;
the delivery information comprises delivery period.

6. The method of claim 5, wherein the configuration information comprises the delivery information; the delivery information comprises the delivery period; and the target binding relation is a binding relation currently in the delivery period.

7. The method of claim 5, wherein configuration information in the target binding relation comprises the display information, wherein the display information comprises the dynamic material library identifier, the dynamic material screening condition and the dynamic material presentation strategy; the dynamic material library comprises a plurality of materials;
the server further determines the first target resource information corresponding to the target configurable area based on the target binding relation comprising:
the server further determines first target resource information associated with the target configurable area from the dynamic material library based on the dynamic material library identifier and the dynamic material screening condition;
the rendering the page to be loaded with first target resource information and second target resource information comprises:
obtaining the first target resource information, the second target resource information and the dynamic material presentation strategy from the server;
rendering the target configurable area in the page to be loaded based on the first target resource information and the dynamic material presentation strategy;
rendering the target non-configurable area in the page to be loaded with the second target resource information.

8. (canceled)

9. An electronic device, comprising:
one or more processors;
a storage for storing one or more programs;
wherein the one or more programs, when executed by the one or more processors, cause the one or more processors to:
obtain a page loading instruction comprising identification information of a page to be loaded, the page to be loaded comprising a target configurable area and a target non-configurable area; and
render the page to be loaded with first target resource information and second target resource information; wherein the first target resource information corresponds to the target configurable area; the first target resource information is variable resource information and determined according to current promotion activity contents; and the second target resource information corresponds to the target non-configurable area; and the second target resource information is fixed resource information, which does not vary with changes of promotion activity contents.

10. A non-transitory computer-readable storage medium stored thereon with instructions, wherein the instructions, when executed by a process, causing a computer device to:
obtain a page loading instruction comprising identification information of a page to be loaded, the page to be loaded comprising a target configurable area and a target non-configurable area; and
render the page to be loaded with first target resource information and second target resource information; wherein the first target resource information corresponds to the target configurable area; the first target resource information is variable resource information and determined according to current promotion activity contents; and the second target resource information corresponds to the target non-configurable area; and the second target resource information is fixed resource information, which does not vary with changes of promotion activity contents.

11. The device of claim 9, wherein before the rendering the page to be loaded with first target resource information and second target resource information, the device is further caused to:
send the page loading instruction to a server, to cause the server to determine the first target resource information and the second target resource information based on identification information of the page to be loaded; and
obtain the first target resource information and the second target resource information from the server.

12. The device of claim 11, wherein,
the server determines the first target resource information based on identification information of the page to be loaded, comprising:
the server determines a target binding relation corresponding to the target configurable area from a binding relation library based on identification information of the page to be loaded;
the binding relation library comprises a plurality of binding relations, the binding relations comprise a corresponding relation among configurable area, material template and configuration information; at least one of the configurable area, the material template and the configuration information is different in different binding relations; and the binding relation is built according to the promotion activity contents; and
the server further determines the first target resource information corresponding to the target configurable area based on the target binding relation.

13. The device of claim 12, wherein,
the target configurable area corresponds to a plurality of candidate material templates; each of the candidate material templates comprises one or more items to be configured;
the material template in the target binding relation is a candidate material template of the plurality of candidate material templates corresponding to the target configurable area; and the configuration information in the target binding relation is information for configuring the items to be configured in the material template in the target binding relation.

14. The device of claim 12, wherein the configuration information comprises display information and/or delivery information;
the display information comprises at least one of: background color, background image, title content, font color, jump link after triggering of the target configurable area, dynamic material library identifier, dynamic material screening condition and dynamic material presentation strategy;
the delivery information comprises delivery period.

15. The device of claim 14, wherein the configuration information comprises the delivery information; the delivery information comprises the delivery period; and the target binding relation is a binding relation currently in the delivery period.

16. The device of claim 14, wherein configuration information in the target binding relation comprises the display information, wherein the display information comprises the dynamic material library identifier, the dynamic material screening condition and the dynamic material presentation strategy; the dynamic material library comprises a plurality of materials;
the server further determines the first target resource information corresponding to the target configurable area based on the target binding relation comprising:
the server further determines first target resource information associated with the target configurable area from the dynamic material library based on the dynamic material library identifier and the dynamic material screening condition;
the instructions causing the device to render the page to be loaded with first target resource information and second target resource information comprise instructions causing the device to:
obtain the first target resource information, the second target resource information and the dynamic material presentation strategy from the server;
render the target configurable area in the page to be loaded based on the first target resource information and the dynamic material presentation strategy;
render the target non-configurable area in the page to be loaded with the second target resource information.

17. The medium of claim 10, wherein before rendering the page to be loaded with first target resource information and second target resource information, the medium further comprises instructions causing the device to:
send the page loading instruction to a server, to cause the server to determine the first target resource information and the second target resource information based on identification information of the page to be loaded; and
obtain the first target resource information and the second target resource information from the server.

18. The medium of claim 17, wherein,
the server determines the first target resource information based on identification information of the page to be loaded, comprising:
the server determines a target binding relation corresponding to the target configurable area from a binding relation library based on identification information of the page to be loaded;
the binding relation library comprises a plurality of binding relations, the binding relations comprise a corresponding relation among configurable area, material template and configuration information; at least one of the configurable area, the material template and the configuration information is different in different binding relations; and the binding relation is built according to the promotion activity contents; and
the server further determines the first target resource information corresponding to the target configurable area based on the target binding relation.

19. The medium of claim 18, wherein,
the target configurable area corresponds to a plurality of candidate material templates; each of the candidate material templates comprises one or more items to be configured;
the material template in the target binding relation is a candidate material template of the plurality of candidate material templates corresponding to the target configurable area; and the configuration information in the target binding relation is information for configuring the items to be configured in the material template in the target binding relation.

20. The medium of claim 18, wherein the configuration information comprises display information and/or delivery information;
the display information comprises at least one of: background color, background image, title content, font color, jump link after triggering of the target configurable area, dynamic material library identifier, dynamic material screening condition and dynamic material presentation strategy;
the delivery information comprises delivery period.

21. The medium of claim 20, wherein the configuration information comprises the delivery information; the delivery information comprises the delivery period; and the target binding relation is a binding relation currently in the delivery period.
